(19) United States
(12) Patent Application Publication
(10) Pub. No.: US 2026/0102865 A1
(43) Pub. Date: Apr. 16, 2026

(54) TOOL HOLDER FOR DELIVERING COOLANT WITH ENHANCED STIFFNESS

(71) Applicant: SHIN-YAIN INDUSTRIAL CO., LTD., Taichung City (TW)

(72) Inventor: PEN HUNG CHEN, Taichung City (TW)

(21) Appl. No.: 18/808,263

(22) Filed: Aug. 19, 2024

(51) Int. Cl. B23Q 11/10

(52) U.S. Cl. CPC B23Q 11/1023

(57) ABSTRACT

A tool holder for delivering coolant with enhanced stiffness has a mounting flange, a connecting portion, and a holding portion. A length of the holding portion is larger than or qual to 4 times of a first length of the mounting flange. A generatrix of the holding portion is a curved line. The holding portion has a third diameter ranging from 0.8 times to 0.9 times of a first diameter of the mounting flange, a fourth diameter being smaller than 0.4 times of the first diameter, and a fifth diameter located at a position of the holding portion separating from a second end of the mounting flange by a first distance. Wherein the first distance is 0.5 times of the first length. The fifth diameter ranges from 0.65 times to 0.75 times of the first diameter. The flexural strength and the stiffness of the holding portion are significantly enhanced.

### BACKGROUND OF THE INVENTION

### 1. Field of the Invention

The present invention relates to a tool holder for holding a cutting tool, and particularly to a tool holder for delivering coolant that has enhanced stiffness.

### 2. Description of Related Art

A conventional tool holder is adapted to be connected to a spindle of a machining center and is configured to hold a cutting tool. The conventional tool holder is driven by the spindle of the machining center to drive the cutting tool to spin for machining. A tool holder for delivering coolant has a coolant channel for coolant fluid passing therethrough. During machining, the coolant fluid runs through the cutting tool and a workpiece to lower a working temperature and to reduce friction between the cutting tool and workpiece.

With reference to FIGS. 5 and 6, a conventional tool holder 90 as shown in FIG. 5 has a holding portion 91 having a conical surface 92 disposed at a front end of the holding portion 91 for clamping a cutting tool. An angle θ1 formed between a generatrix of the conical surface 92 and a central axis is 4.5°. A conventional tool holder 90A as shown in FIG. 6 has a holding portion 91A which is conical as a whole and has a conical surface. In FIG. 6, an angle θ2 formed between a generatrix of the conical surface to a central axis is 3°. However, the holding portions 91, 91A of the conventional tool holders 90, 90A are elongated and thin, thereby reducing the stiffness thereof.

To overcome the shortcomings of the conventional tool holder mentioned above, the present invention provides a tool holder for delivering coolant with enhanced stiffness to mitigate or obviate the aforementioned problems.

### SUMMARY OF THE INVENTION

The main objective of the present invention is to provide a tool holder for delivering coolant with enhanced stiffness.

The tool holder for delivering coolant with enhanced stiffness comprises a mounting flange, a connecting portion, and a holding portion. The mounting flange has a first end, a second end, a first diameter, and a first length defined as a distance between the first end and the second end. The connecting portion extends from the first end of the mounting flange and has a second diameter being smaller than the first diameter. The holding portion extends from the second end of the mounting flange and has a generatrix being a curved line, a length being larger than or equal to 4 times of the first length, a third diameter defined at an edge between the holding portion and the mounting flange, a fourth diameter defined at a front end of the holding portion away from the mounting flange, and a fifth diameter defined at a position on the holding portion separating from the second end of the mounting flange by a first distance. Wherein, the third diameter is smaller than the first diameter and larger than or equal to the second diameter and ranges from 0.8 times to 0.9 times of the first diameter. The fourth diameter is smaller than the third diameter and is smaller than 0.4 times of the first diameter. The first distance is 0.5 times of the first length. The fifth diameter ranges from 0.65 times to 0.75 times of the first diameter.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a tool holder for delivering coolant with enhanced stiffness in accordance with the present invention;

FIG. 2 is a side view of the tool holder for delivering coolant with enhanced stiffness in FIG. 1;

FIG. 3 is another side view of the tool holder for delivering coolant with enhanced stiffness in FIG. 1;

FIG. 4 is a cross-sectional end view of the tool holder for delivering coolant with enhanced stiffness along line 4-4 in FIG. 2;

FIG. 5 is a side view of a conventional tool holder in accordance with the prior art;

FIG. 6 is a side view of another conventional tool holder in accordance with the prior art;

FIG. 7 is a side view of the tool holder in accordance with the present invention in FIG. 2 comparing with the conventional tool holders in FIGS. 5 and 6; and

FIG. 8 is a schematic diagram for comparing a diameter of the tool holder in accordance with the present invention along line 8-8 in FIG. 7 with diameters respective of the conventional tool holders in FIGS. 5 and 6.

### DETAILED DESCRIPTION OF THE PREFERRED EMBODIMENT

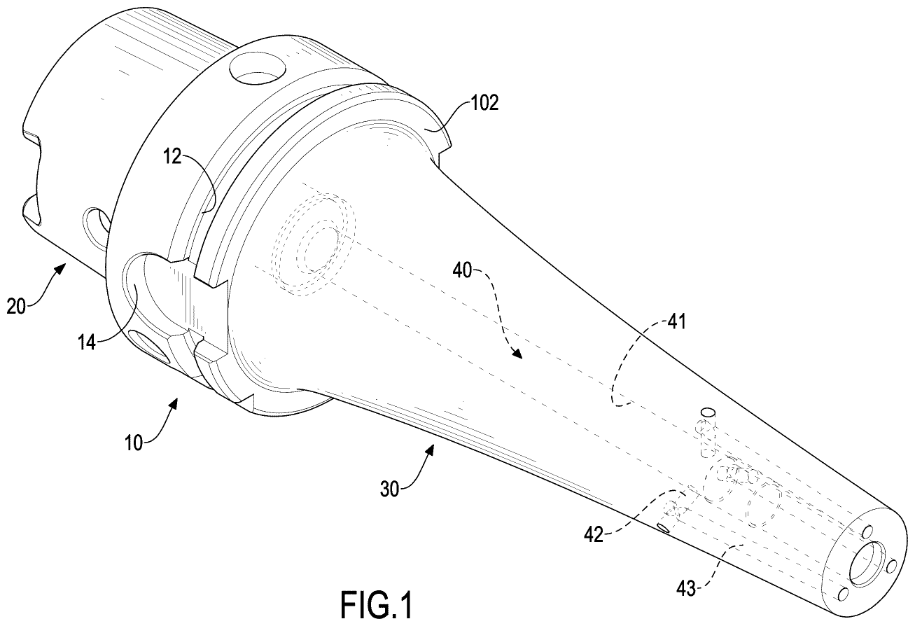

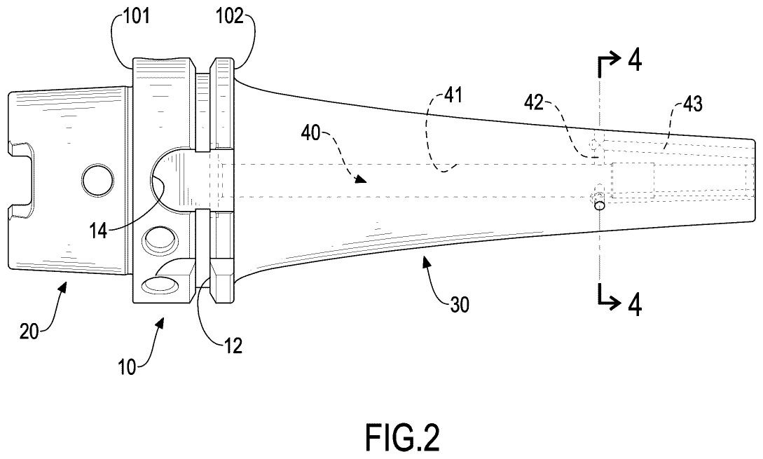

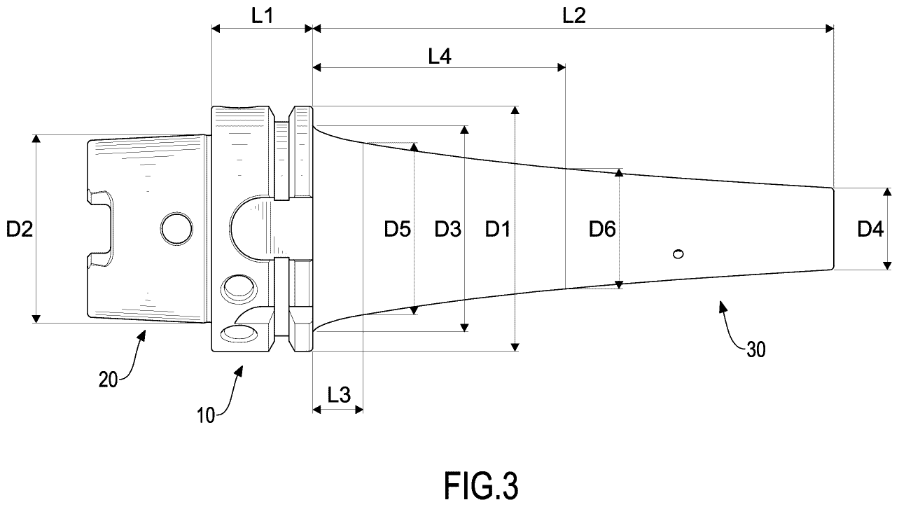

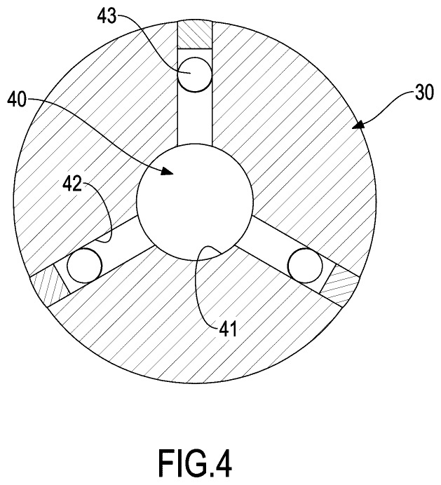

With reference to FIGS. 1 to 4, a tool holder for delivering coolant with enhanced stiffness in accordance with the present invention has a mounting flange 10, a connecting portion 20, and a holding portion 30.

The mounting flange 10 has a first end 101, a second end 102, and a first diameter D1. The first end 101 and the second end 102 are respectively at two opposite ends of the mounting flange 10. The first diameter D1 is a maximum diameter of the mounting flange 10. The mounting flange 10 may have an annular groove 12 and at least one engaging recess 14 for connecting with a spindle of a machining center. A first length L1 is defined as a distance from the first end 101 to the second end 102 of the mounting flange 10.

The connecting portion 20 extends from the first end 101 of the mounting flange 10 and is configured to be connected with the spindle of the machining center. The connecting portion 20 has a second diameter D2. The second diameter D2 is a maximum diameter of the connecting portion 20 and is smaller than the first diameter D1.

The holding portion 30 extends from the second end 102 of the mounting flange 10 and is configured for holding a cutting tool. A length L2 of the holding portion 30 is larger than or equal to 4 times of the first length L1 and less than or equal to 7 times of the first length L1. In the embodiment, the length L2 of the holding portion 30 ranges from 5 times to 5.5 times of the first length L1. In a side view, a generatrix of the holding portion 30 is a curved line. The holding portion 30 has a third diameter D3, a fourth diameter D4, and a fifth diameter D5. Wherein, the third diameter D3 is defined at an edge between the holding portion 30 and the mounting flange 10. The third diameter D3 is smaller than the first diameter D1 and is larger than the second diameter D2. The third diameter D3 ranges from 0.8 times to 0.9 times of the first diameter D1.

The fourth diameter D4 is defined at a front end of the holding portion 30 away from the mounting flange 10. The fourth diameter D4 is smaller than the third diameter D3 and is smaller than 0.4 times of the first diameter D1. Preferably, the fourth diameter D4 ranges from 0.25 times to 0.36 times of the first diameter D1.

The fifth diameter D5 is defined at a position on the holding portion 30 separating from the second end 102 of the mounting flange 10 by a first distance L3. The first distance L3 is 0.5 times of the first length L1. The fifth diameter D5 ranges from 0.65 times to 0.75 times of the first diameter D1.

Moreover, the holding portion 30 has a sixth diameter D6. The sixth diameter D6 is defined at a position on the holding portion 30 separating from the second end 102 of the mounting flange 10 by a second distance L4. The second distance L4 is 2.5 times of the first length L1. The sixth diameter D6 ranges from 0.45 times to 0.55 times of the first diameter D1.

Furthermore, the tool holder for delivering coolant with enhanced stiffness comprises a coolant delivery channel 40 for fluidly communicating with a coolant system of the machining center. The coolant delivery channel 40 includes a major channel 41, multiple communicating channels 42, and multiple sub-channels 43. The major channel 41 extends along an extending direction of the holding portion 30. The communicating channels 42 are arranged around the major channel 41 at angular intervals and are located between two opposite ends of the holding portion 30 and are spaced apart from the front end of the holding portion 30. Each communicating channel 42 radially extends to fluidly communicate with the major channel 41. The multiple sub-channels 43 are arranged at angular intervals and extend from the front end of the holding portion 30 toward the mounting flange 10 to respectively fluidly communicate with the multiple communicating channels 42.

Preferably, each sub-channel 43 tilts relative to the major channel 41. A radial distance between an end of each sub-channel 43 at the front end of the holding portion 30 and the major channel 41 is smaller than a radial distance between an end of the sub-channel 43 away from the front end of the holding portion 30 and the major channel 41.

The coolant fluid flowing into the coolant delivery channel 40 may flow into a channel of a cutting tool mounted in the holding portion 30 via the major channel 41 and spray out from the channel of the cutting tool to lower the temperature of the cutting tool. A part of the coolant fluid may flow into the multiple sub-channels 43 via the multiple communicating channels 42 and spray out from the front end of the holding portion 30 and spray on the periphery of the cutting tool, thereby enhancing the cooling effect.

Since the length L2 of the holding portion 30 is larger than or equal to 4 times of the first length L1, the cutting tool may be deeply inserted into the holding portion 30 by a longer length, thereby improving the machining stability.

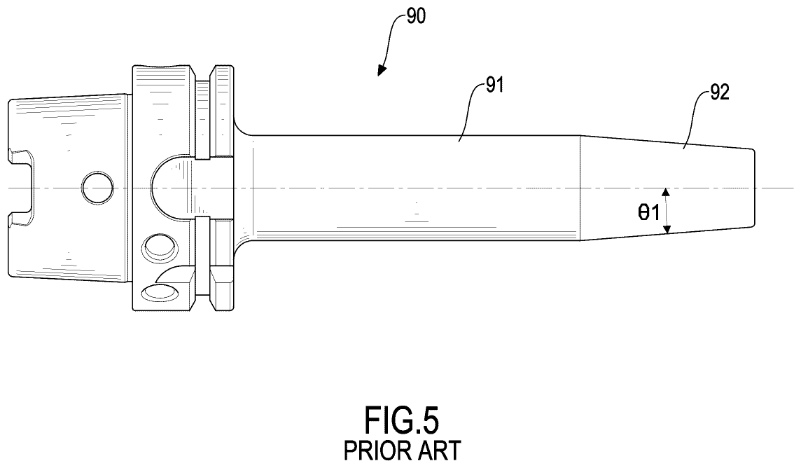

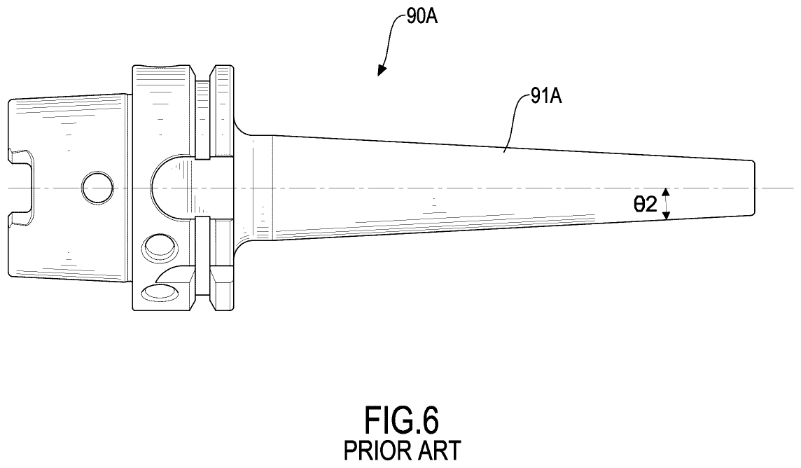

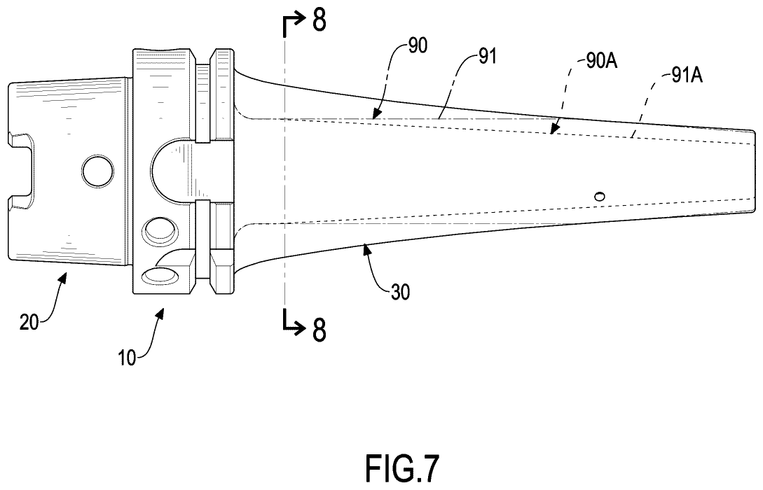

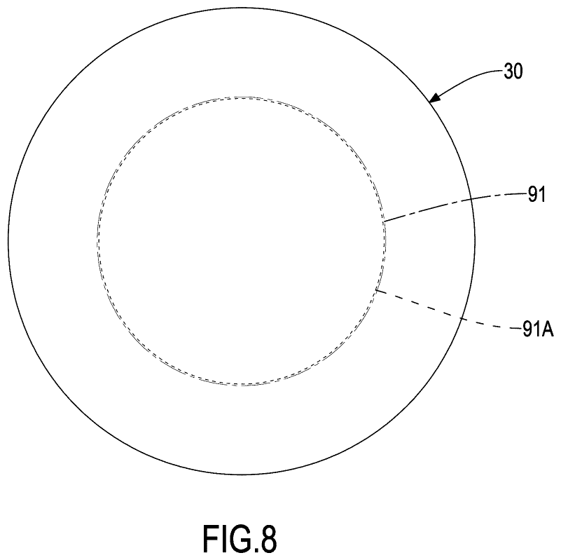

With reference to FIGS. 7 and 8, comparing the tool holder in accordance with the present invention with the conventional tool holders 90, 90A as shown in FIGS. 5 and 6, we could find that the diameter of the holding portion 30 of the tool holder in accordance with the present invention adjacent to the mounting flange 10, e.g. at a position separating from the mounting flange 10 by the first distance, is larger than the diameter of the holding portion 91 of the conventional tool holder 90 in FIG. 5 at a similar position and is also larger than the diameter of the holding portion 91A of the conventional tool holder 90A in FIG. 6 at a similar position.

Stiffness is an extent to which an object resists deformation under a magnitude of force and can be calculated according to the formula below:

$$K = AE / L$$

Wherein, K is the stiffness, A is the cross-sectional area (m²), E is the elastic modulus (Mpa), and L is the length (m) of the object. The elastic modulus is a property of the constituent material. Consequently, the stiffness will be reduced because of longer length of and/or smaller cross-sectional area of the object.

To enhance the stiffness of the tool holder, the generatrix of the holding portion 30 is curved, the third diameter D3 ranges from 0.8 times to 0.9 times of the first diameter D1 of the mounting flange 10, and the fifth diameter D5 ranges from 0.65 times to 0.75 times of the first diameter D1, the cross-sectional area of the holding portion 30 is gradually smaller. Accordingly, the flexural strength and the stiffness of the holding portion 30 are significantly enhanced.

What is claimed is:

1. A tool holder for delivering coolant comprising:
a mounting flange having
a first end;
a second end opposite to the first end;
a first diameter; and
a first length defined as a distance between the first end and the second end;
a connecting portion extending from the first end of the mounting flange and having
a second diameter being smaller than the first diameter;
a holding portion extending from the second end of the mounting flange and having
a generatrix being a curved line;
a length being larger than or equal to 4 times of the first length;
a third diameter defined at an edge between the holding portion and the mounting flange, being smaller than the first diameter and larger than or equal to the second diameter, and ranging from 0.8 times to 0.9 times of the first diameter;
a fourth diameter defined at a front end of the holding portion away from the mounting flange, being smaller than the third diameter, and being smaller than 0.4 times of the first diameter; and
a fifth diameter defined at a position on the holding portion separating from the second end of the mounting flange by a first distance, wherein the first distance is 0.5 times of the first length, and the fifth diameter ranges from 0.65 times to 0.75 times of the first diameter.

2. The tool holder as claimed in claim 1, wherein the holding portion has a sixth diameter defined at a position on the holding portion separating from the second end of the mounting flange by a second distance, wherein the second distance is 2.5 times of the first length, and the sixth diameter ranges from 0.45 times to 0.55 times of the first diameter.

3. The tool holder as claimed in claim 1, wherein
the length of the holding portion is less than or equal to 7 times of the first length;
the fourth diameter ranges from 0.25 times to 0.36 times of the first diameter.

4. The tool holder as claimed in claim 1, wherein
the tool holder comprises a coolant delivery channel; and
the coolant delivery channel includes a major channel extending along the holding portion.

5. The tool holder as claimed in claim 2, wherein
the tool holder comprises a coolant delivery channel; and
the coolant delivery channel includes a major channel extending along the holding portion.

6. The tool holder as claimed in claim 3, wherein
the tool holder comprises a coolant delivery channel; and
the coolant delivery channel includes a major channel extending along the holding portion.

7. The tool holder as claimed in claim 4, wherein
the coolant delivery channel includes multiple communicating channels and multiple sub-channels;
the multiple communicating channels are arranged around the major channel at angular intervals, and each of the multiple communicating channels radially extends to fluidly communicate with the major channel; and
the multiple sub-channels are arranged at angular intervals and extend from the front end of the holding portion toward the mounting flange to respectively fluidly communicate with the multiple communicating channels.

8. The tool holder as claimed in claim 5, wherein
the coolant delivery channel includes multiple communicating channels and multiple sub-channels;
the multiple communicating channels are arranged around the major channel at angular intervals, and each of the multiple communicating channels radially extends to fluidly communicate with the major channel; and
the multiple sub-channels are arranged at angular intervals and extend from the front end of the holding portion toward the mounting flange to respectively fluidly communicate with the multiple communicating channels.

9. The tool holder as claimed in claim 6, wherein
the coolant delivery channel includes multiple communicating channels and multiple sub-channels;
the multiple communicating channels are arranged around the major channel at angular intervals, and each of the multiple communicating channels radially extends to fluidly communicate with the major channel; and
the multiple sub-channels are arranged at angular intervals and extend from the front end of the holding portion toward the mounting flange to respectively fluidly communicate with the multiple communicating channels.

10. The tool holder as claimed in claim 7, wherein each of the multiple sub-channels tilts relative to the major channel.

11. The tool holder as claimed in claim 8, wherein each of the multiple sub-channels tilts relative to the major channel.

12. The tool holder as claimed in claim 9, wherein each of the multiple sub-channels tilts relative to the major channel.

13. The tool holder as claimed in claim 10, wherein the length of the holding portion ranges from 5 times to 5.5 times of the first length.

14. The tool holder as claimed in claim 11, wherein the length of the holding portion ranges from 5 times to 5.5 times of the first length.

15. The tool holder as claimed in claim 12, wherein the length of the holding portion ranges from 5 times to 5.5 times of the first length.
